(19) United States
(12) Patent Application Publication
(10) Pub. No.: US 2025/0333655 A1
(43) Pub. Date: Oct. 30, 2025

(54) PROCESSES FOR OBTAINING BIOFUELS

(71) Applicants: JUAN DIEGO PABLO FERRES DELLAPIANE, São Paulo (BR); DONATO ALEXANDRE GOMES ARANDA, Rio Janeiro (BR)

(72) Inventors: JUAN DIEGO PABLO FERRES DELLAPIANE, São Paulo (BR); DONATO ALEXANDRE GOMES ARANDA, Rio Janeiro (BR)

(21) Appl. No.: 19/039,062

(22) Filed: Jan. 28, 2025

(30) Foreign Application Priority Data
Feb. 6, 2024 (BR) 1020240024540

(51) Int. Cl. C10G 3/00

(52) U.S. Cl. CPC C10G 3/40; C10G 3/44; C10G 2300/1014; C10G 2300/1018

(57) ABSTRACT

Use of short-chain alcohols as fatty acid extracting solvents present in oils and fats, in a multistage system. At the end of the last stage there is a low acid ester, raffinate, and an extract, containing fatty acids and methanol, which return to the beginning of the enzymatic esterification, where they receive more fatty acids from the hydrolysis step. Thus, there is a full integration of all unit operations involved in this process.

The present invention is located in the field of chemistry, specifically fuels, more specifically renewable fuels, such as biodiesels and biokerosenes, exactly a process that uses short-chain alcohols as fatty acid extracting solvents present in oils and fats, in a multi-stage system, synergistically integrated with liquid-liquid extraction (LLE).

The production of biodiesel is almost always carried out through transesterification reaction, with basic catalysts. It is the chemical reaction of a vegetable oil or animal fat with a short-chain alcohol (methanol or ethanol) in the presence of a catalyst. In fact, in the entire chemical industry, few processes have a yield that can be greater than 99% under mild conditions of temperature and atmospheric pressure. This is the case in most industrial biodiesel plants. However, for this to occur, there is an important condition: lipids must have very low acidity, which is common for most virgin vegetable oils such as soybean, canola, and sunflower oils, among others. However, there are many cases where the acidity is significantly higher than 1-2%, especially for some fats, used frying oils and palm oils, such as African palm or macauba. Oilseed raw materials account for almost 90% of the cost of producing biodiesel. Oils and fats of higher acidity are usually cheaper and the most common treatment is the “pre-esterification” of free fatty acids with methanol, in the presence of acid catalysts such as sulfuric acid, or para-toluene sulfonic acid, both of which are quite corrosive. In addition, these catalysts have a non-negligible cost and will consume part of the basic transesterification catalyst downstream. The additional costs of these catalysts may not be as bothersome as the inexorable presence of salts that are formed by the reaction between the acidic and basic catalysts. Such salts tend to accumulate in the plant causing serious heat exchange problems, fouling and loss of product quality. A more selective solution to these fatty acids would be most welcome for the reasons set out above. One option is chemical refining, but this only applies to the presence of free fatty acid contents below 2-3% since the soaps generated in this step tend to generate emulsions that absorb a significant amount of neutral oil, resulting in a significant yield loss. In addition, the amount of waste generated is growing, increasing the costs of this additional treatment. Physical refining, a vacuum distillation with steam drag, applies at higher acidity values. However, it has a high energy cost and the partial drag of the neutral oil limits its use.

An in-depth analysis of the current technology reveals a gap in processes for producing high-yield biofuels, as can be seen in patent GB1282926, “Esterification and extraction process”, filed by El Paso Products Co. on Oct. 10, 1968, for a process for separating esterifiable aliphatic carboxylic acids mixed with other aliphatic carboxylic acids mixed in aqueous solutions, the mixture is placed in contact with an alkyl alcohol (1-5° C.), alkylene glycol or their ether derivatives at temperatures of 25 degrees B.P. in the presence of an esterification catalyst and simultaneously and countercurrently contacted with a water-immiscible organic solvent to extract the esters as formed, partitioning into an organic phase containing at least a portion of the esters and an aqueous phase containing excess water-miscible solvent, non-esterified organic acids and water, stratifying and separating the two phases, distilling the organic phase to recover the solvent and esters and distilling the aqueous phase to recover any excess water-miscible solvent and the residue. The aqueous solution can be mixtures of at least two monocarboxylic acids, saturated or unsaturated, substituted or unsubstituted, a dicarboxylic acid that is saturated or unsaturated, substituted or unsubstituted, and tri- or polycarboxylic acids and many are listed, for example, the mixed acids obtained by the nitric acid oxidation of cyclohexanol and cyclohexanone, and of fats and fatty acids; the oxidation of paraffins; the hydration of maleic acid; the fermentation processes that produce lactic, oxalic or citric acids; and carbohydrate degradation processes producing levulinic acid. The water-immiscible solvents may be aliphatic, cycloaliphatic and aromatic hydrocarbons and aliphatic or aromatic halogenated hydrocarbons. The process is illustrated using an apparatus comprising a series of three feed tanks, three extractors and two clarifiers to provide a continuous system. Examples describe the extraction of dimethyl esters of mixed succinic, glutaric and adipic acids from the oxidation of cyclohexanol and cyclohexanone nitric acid, and from the oxidation of cyclohexane nitric acid; esters of oleic oxidation acids and resin oil; mixed esters of maleic and cyanacetic acids, esters of mixed oxalic, malonic, succinic, glutaric and alipic acids, esters of mixed acids from the hydration of maleic acid; esters of technical quality aconitic, lactic and levulinic acids and acids derived from sucrose hydrolysis.

In addition, document CN102229865, “Method for preparing low-cold-filter-plugging-point biodiesel”, from University Beijing Chemical, with a priority date of May 2011, describes a method for preparing biodiesel with a low cold filter plugging point, which comprises the following steps: preparation of free fatty acids by hydrolysis of the feedstock grease; separation of free fatty acids by a urea clathrate process to obtain a fraction containing rich saturated fatty acids and a fraction containing rich unsaturated fatty acids; and carry out the esterification reaction of the fraction containing rich saturated fatty acids, which are obtained by the step, with short-chain alkanols and the esterification reaction of the fraction containing rich unsaturated fatty acids, which are obtained by the step, with methanol, mixing the two parts of fatty acid esters obtained by the reactions uniformly and obtaining biodiesel with better low-temperature flow properties. The method for improving the low temperature flow property of short chain alkanol biodiesel is simple to operate, is highly adaptable to feedstock oils and can achieve a high utilization rate; and the physical and chemical properties of the product prepared by the method meet the values specified in the standards for biodiesel.

Finally, protection JP2000143587, “Production of aliphatic ester compound”, filed by Ube Industries on Nov. 10, 1998, describes an adipic diester is obtained by hydroesterification of an olefin derivative, pref. an α-olefin monoester such as methyl 4-pentanoate in the presence of carbon monoxide and alcohol such as methanol in an acidic atmosphere using a metal carbonyl cluster as a pref. catalyst under the pressure of component B at 40-6,050 kg/cm2 pref. at 130-160 degrees C. for 8-9 h; wherein it is preferred that the above catalyst be such that a rhodium carbonyl cluster catalyst of the formula: Rh4(CO)12 or the like is carried on a zeolite solid acid, such as H-zeolite (A3).

In view of the gaps in the technique, the proposed invention is the use of short-chain alcohols (methanol, ethanol) as fatty acid extracting solvents present in oils and fats, in a multistage system. At the end of the last stage there is a low acid ester, raffinate, and an extract, containing fatty acids and methanol or any short-chain alcohols, which return to the beginning of the enzymatic esterification, where they receive more fatty acids from the hydrolysis step. Thus, there is a full integration of all unit operations involved in this process.

Instead of using tools to remove the fatty acids naturally present in crude oils, one can, through enzymatic or hydrothermal hydrolysis reactions (or combination of both) transform all triglycerides, diglycerides and monoglycerides into fatty acids and glycerin. These fatty acids can be used as such in various applications in the oleochemical industry but can also be transformed into hydrocarbons by the HEFA route. Alternatively, they can be transformed into methyl or ethyl esters and one of the most effective and clean ways to do this is through enzymatic esterification, chemical and reactive distillation. It turns out that, typically, at the end of esterification, there is still the presence of free fatty acids at levels above that allowed in the biodiesel specifications. These fatty acids can be removed by extraction. The use of solvents for liquid-liquid extraction (LLL) is a possible option. LLE, also known as partitioning, is a separation process consisting of the transfer of a solute from one solvent to another, the two solvents being immiscible or partially miscible with each other. As in all extraction processes, the liquid-liquid extraction comprises a mixing (contact) step, followed by a phase separation step. It is important to consider both steps when selecting solvents and modes of operation. Thus, although vigorous mixing is favorable to the transfer of the extractable from one solvent to the other, it can also impair the ease of phase separation by the formation of emulsions. Given a solvent, the residual liquid solution from which the solute is drawn is called a raffinate and the product-rich solvent is called an extract. In the specific case, the solvent should be as selective as possible for the solubilization of free fatty acids and not triglycerides. Hexane, for example, is an excellent solvent for lipids, but does not exhibit the desired selectivity. The present invention proposes the use of short-chain alcohols (methanol or ethanol) as extracting solvents for fatty acids present in oils and fats, in a multi-stage system. At the end of the last stage we have a low acid ester, raffinate, ready to be stored in tanks and shipped to the distributors. The extract, containing fatty acids and methanol, returns to the beginning of the enzymatic esterification, where it will receive more fatty acids from the hydrolysis step. Thus, there is a full integration of all unit operations involved in this process, bringing the benefits of reducing the consumption of catalysts and avoiding fouling and loss of product quality.

The synergistic processes for high yield of obtaining biofuels can be synthesized as follows: its main steps: hydrolysis—enzymatic, hydrothermal or combination of both—of vegetable oils or animal fats generating glycerin and fatty acids; esterification of fatty acids; removal of remaining fatty acids by liquid-liquid extraction process.

Alternatively, hydrolysis occurs in a continuous countercurrent column process, in the oil:water mass ratio is 1:0.8 to 1:1.2, reaction temperature between 24° and 270° C., operating pressure between 40 and 60 bar and spatial time between 0.5 and 2 hours.

Alternatively, hydrolysis occurs in batch process in the presence of lipases, at a temperature of 35 to 50° C. and pressure of 1 to 2 bar.

Alternatively, esterification occurs with methanol or ethanol or propanol or butanol or a mixture of these alcohols, catalyzed by lipase-type enzymes or enzymatic broths obtained from plant extracts or catalyzed by sulfuric acid or para-toluene sulfonic acid or methanesulfonic acid, the catalyst concentration relative to fatty acid being 0.5% to 3%, the reaction temperature in the range of 120 to 180° C., the reaction pressure in the range of 1 to 25 bar, the alcohol: fatty acid molar ratio ranging from 1 to 10, and the reaction temperature is in the range of 40 to 60° C. and atmospheric pressure.

Alternatively, the extraction of fatty acids present in vegetable oils, fats and esters uses alcohols in multiple stages, generating a raffinate and an extract that are integrated into the biodiesel production unit, the alcohols being methanol, ethanol, propanol, butanol or a mixture of them; the process takes place at a temperature of 20 to 60° C., in 2 to 10 stages in series, from 1 to 5 bar in which the raffinate is taken to the biodiesel production unit and its intermediates, subjected to alcoholic neutralization, followed by transesterification with the production of alkyl esters, followed by washing, drying and filtering of the final biodiesel, the extract being taken to the esterification or glycerolysis unit for the production of biodiesel and its intermediates and the alcohol/oil mass ratio is 0.5:1 to 1.5:1, respectively.

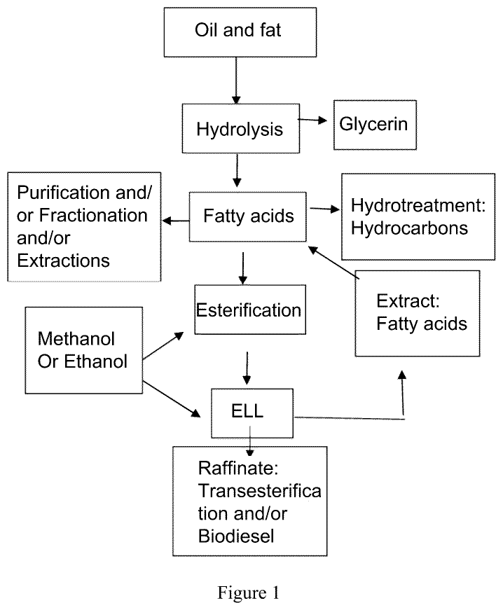

The invention can be better understood by means of FIG. 1, which illustrates the step of liquid-liquid extraction (LLE) of fatty acids with alcohols: multistage liquid-liquid extraction scheme.

### EXAMPLES

Example 1—Animal fat with 5.5% free fatty acids, phosphorus content of 19 ppm and humidity of 0.3%, submitted to an extraction system with seven stages, at a temperature of 40° C. and fed 800 kg/h of methanol for each ton of animal fat generates as a result a raffinate of 2.2% acidity and an extract with 25% acidity with a spatial time of 90 minutes.

Example 2—Animal fat with 5.5% free fatty acids is subjected to hydrolysis with lipases at 450° C. for 8 hours, obtaining conversion of 72% to fatty acids. After separation of the aqueous phase containing glycerin, from the oil phase containing fatty acids, triglycerides, diglycerides and monoglycerides, this lipid phase is subjected to countercurrent tower hydrolytic scission in a 1:1 mass ratio (water: lipid fraction) at 255° C. and 55 bar pressure. In the upper stream of the column, 99.2% of free fatty acids are obtained, while at the base of the column the aqueous solution containing glycerin is obtained. The obtained fatty acids were then subjected to esterification by reactive distillation on a 12-course column with methanol countercurrent feed. At the top of the column, a methanol/water mixture is obtained, which is sent to recover the methanol in an appropriate column. At the bottom of the column, methyl ester with 2.3% fatty acids is obtained. Animal fat methyl ester with 2.3% free fatty acids, phosphorus content of 21 ppm and humidity of 0.8%, submitted to an extraction system with seven stages, at a temperature of 45° C. and fed with 850 kg/h of methanol for each ton of animal fat, results in a raffinate methyl ester compound with 0.2% acidity, being specified as biodiesel and an extract with 18% acidity with a spatial time of 70 minute.

The invention may be better understood with the aid of the figures.

FIG. 1 is a flowchart of the synergistic integration of high throughput processes.

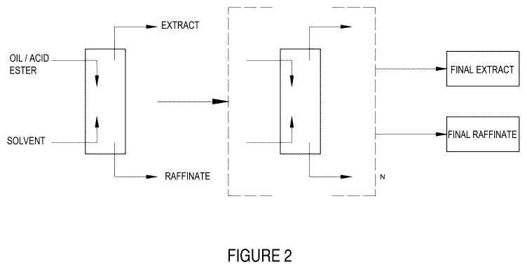

FIG. 2 is a flowchart of the liquid-liquid extraction sub-process.

In summary, the new process brings the benefits of reducing catalyst consumption and avoids fouling and loss of product quality.

This innovation is not limited to the representations commented or illustrated herein, and should be understood in its broad scope. Many modifications and other representations of the invention will come to the mind of one skilled in the art to which this invention belongs, having the benefit of the teaching presented in the previous descriptions and attached drawings. Furthermore, it is to be understood that the invention is not limited to the specific form disclosed, and that modifications and other forms are understood to be included within the scope of the appended claims. Although specific terms are employed herein, they are used only in a generic and descriptive manner and not for the purpose of limitation.

1. (canceled)

2. (canceled)

3. (canceled)

4. (canceled)

5. (canceled)

6. A process for obtaining biofuels characterized by integrating hydrolysis, esterification and extraction operations, being able to use vegetable oils or animal fats even if they have high acidity and comprise the following steps:
(a) hydrolysis of vegetable oils or animal fats, to produce fatty acids and glycerin, and hydrolysis can be carried out in one of the following ways:
(i) enzymatic hydrolysis, carried out in batch, in the presence of lipases, at a temperature of 35° C. to 50° C., pressure of 1 to 2 bar and duration of 0.5 to 2 hours;
(ii) hydrothermal hydrolysis, carried out in a continuous process in a countercurrent column, with an oil:water mass ratio of 1:0.8 to 1:1.2, temperature from 240° C. to 270° C., pressure from 40 to 60 bar and spatial time between 0.5 and 2 hours;
(iii) combination of enzymatic and hydrothermal hydrolysis;
(b) esterification of the fatty acids obtained in the hydrolysis step, using short-chain alcohols, catalyzed by:
(i) lipase-type enzymes, or
(ii) sulfuric acid, para-toluene sulfonic acid or methanesulfonic acid;
(iii) where the esterification occurs at a temperature of 120° C. to 180° C., pressure of 1 to 25 bar, and an alcohol: fatty acid molar ratio ranging from 1:1 to 10:1;
(c) removal of remaining fatty acids;
(d) integration of operations, in which:
(i) the resulting low acid ester is conducted to the biofuel production unit;
(ii) the extract, containing fatty acids and alcohols, returns to the beginning of the enzymatic esterification process, to receive more fatty acids from hydrolysis.

7. The process according to claim 6, characterized by the removal of remaining fatty acids from (c) can be carried out by an esterification, preferably by means of a multi-stage partitioning or liquid-liquid extraction (LLE) process, using short-chain alcohols as extracting solvents, wherein:
(i) the process takes place at a temperature of 20° C. to 60° C., in 2 to 10 stages, under a pressure of 1 to 5 bar;
(ii) the alcohol:oil mass ratio is 0.5:1 to 1.5:1.

8. The process of claim 6, characterized by the short-chain alcohols from both the esterification phase and the removal of fatty acids can be selected from methanol, ethanol, propanol, butanol, or a mixture of these alcohols.

9. The process according to claim 6, characterized by the esterification preferably occurs with methanol or ethanol, propanol, butanol or a mixture of these alcohols, catalyzed by lipase-type enzymes or enzymatic broths obtained from plant extracts or catalyzed by sulfuric acid or para-toluene sulfonic acid or methanesulfonic acid, the catalyst concentration relative to the fatty acid being 0.5% to 3%, the reaction temperature in the range of 120° C. to 180° C., the reaction pressure in the range of 1 to 25 bar, the alcohol: fatty acid molar ratio ranging from 1 to 10, and the reaction temperature being in the range of 40° C. to 60° C. and atmospheric pressure.

10. The process according to claim 6, characterized by the extraction of the fatty acids present in vegetable oils, fats and esters, using alcohols in multiple stages, generating a raffinate and an extract that are integrated into the biodiesel production unit, the alcohols selected being between methanol, ethanol, propanol, butanol or a mixture of them; the process takes place at a temperature of 20° C. to 60° C., in 2 to 10 stages in series, from 1 to 5 bar in which the raffinate is taken to the biodiesel production unit and its intermediates, subjected to alcoholic neutralization, followed by transesterification with the production of alkyl esters, followed by washing, drying and filtering of the final biodiesel, the extract being taken to the esterification or glycerolysis unit for the production of biodiesel and its intermediates and the alcohol/oil mass ratio is 0.5:1 to 1.5:1.

11. A system for obtaining biofuels, characterized by the fact that it can be made from vegetable oils or animal fats of low or high acidity and comprises:
(a) hydrolysis reactor, configured to perform the hydrolysis of vegetable oils or animal fats, which may operate in:
(i) a continuous process in a countercurrent column, with an oil:water mass ratio of 1:0.8 to 1:1.2, temperature from 240° C. to 270° C., pressure from 40 to 60 bar and spatial time of 0.5 to 2 hours; or
(ii) batch process, using lipases, operating at a temperature of 35° C. to 50° C. and pressure of 1 to 2 bar, for a period of 0.5 to 2 hours;
(b) an esterification unit, connected to the hydrolysis reactor, configured to perform esterification of the resulting fatty acids, using short-chain alcohols, being catalyzed by:
(i) lipase-type enzymes or
(ii) sulfuric acid, para-toluene sulfonic acid or methanesulfonic acid;
(iii) the esterification occurs at a temperature of 120° C. to 180° C., pressure of 1 to 25 bar, and an alcohol: fatty acid molar ratio from 1:1 to 10:1;
(c) a liquid-liquid extraction (LLE) unit, configured to remove fatty acids remaining from the esterification step, using short-chain alcohols as solvents, where:
(i) the process takes place at a temperature of 20° C. to 60° C., in 2 to 10 stages, under a pressure of 1 to 5 bar;
(ii) the alcohol:oil mass ratio is 0.5:1 to 1.5:1;
(d) an integration unit, configured to:
(i) transport the low-acid ester resulting from the extraction stage to a biofuel production unit, where the ester will be stored or processed;
(ii) rerouting the extract, containing fatty acids and alcohols, to the esterification unit, allowing it to be recirculated for further esterification steps.

12. The system of claim 11, characterized by the short-chain alcohols can be selected from methanol, ethanol, propanol, butanol, or a mixture of these alcohols.

13. Method of using short-chain alcohols as fatty acid extracting solvents present in vegetable oils or animal fats characterized by being used in the production of biofuels in a multistage system and comprising the following steps:
(a) hydrolysis of vegetable oils or animal fats to obtain fatty acids, carried out by enzymatic hydrolysis, hydrothermal hydrolysis or a combination of both;
(b) esterification of the fatty acids with short-chain alcohols, using enzymatic or acid catalysts;
(c) removal of fatty acids remaining after esterification, by means of a liquid-liquid extraction (LLE) process, where the short-chain alcohols act as solvents, in an operation with 2 to 10 stages, under temperature of 20° C. to 60° C. and pressure of 1 to 5 bar;
(d) integration of the resulting low acidity ester into the biofuel production unit, while the extract, containing fatty acids and alcohols, returns to the start of enzymatic esterification.

14. The method of claim 13, characterized by the short-chain alcohols can be selected from methanol, ethanol, propanol, butanol, or a mixture of these alcohols.
